(19) United States
(12) Patent Application Publication
(10) Pub. No.: US 2015/0085057 A1
(43) Pub. Date: Mar. 26, 2015

(54) OPTIMIZED SHARING FOR MOBILE CLIENTS ON VIRTUAL CONFERENCE

(71) Applicant: CISCO TECHNOLOGY, INC., San Jose, CA (US)

(72) Inventors: Hua Ouyang, Suzhou (CN); Yi Lu, Suzhou (CN); Huahua Yin, Suzhou (CN); Qi Shi, Suzhou (CN); Yunwei Luo, Suzhou (CN)

(73) Assignee: CISCO TECHNOLOGY, INC., San Jose, CA (US)

(21) Appl. No.: 14/037,036

(22) Filed: Sep. 25, 2013

(51) Int. Cl. H04N 7/15

(52) U.S. Cl. CPC H04N 7/15
USPC 348/14.02

(57) ABSTRACT

In an example, a mobile device such as a tablet, phone, or similar, is configured for use with a virtual conference software provided by a virtual conference server. The mobile device is configured to receive one or more triggers such as battery-below-threshold, switch to a low-bandwidth data network, signal-below-threshold, switch to hands-free mode, switch to a short-range transceiver, lock screen, etc. Upon receiving the trigger, the mobile device enters a reduced-functionality state, where at least part of the virtual conference stream is disabled.

### FIELD OF THE DISCLOSURE

This specification relates in general to the field of communications and, more particularly, to managing mobile devices participating in a virtual conference.

### BACKGROUND

In certain architectures, service providers and/or enterprises may seek to offer sophisticated online conferencing services for their end users. A virtual conference architecture can offer an “in-person” conference experience over a network. Virtual conference architectures can also deliver real-time interactions between people using advanced visual, audio, and multimedia technologies. Virtual conferences are appealing because they can be held without the associated travel inconveniences and costs. In addition, virtual conferences can provide a sense of community to participants who are dispersed geographically.

### BRIEF DESCRIPTION OF THE DRAWINGS

The present specification is best understood from the following detailed description when read with the accompanying figures.

FIG. 1 is a network diagram of a virtual conference according to an example embodiment of the present disclosure.

FIG. 2 is a plurality of block diagrams of endpoints according to an example embodiment of the present disclosure.

FIG. 3 is a user interface element of a mobile device according to an example embodiment of the present disclosure.

FIG. 4 is a user interface element of a mobile device according to an example embodiment of the present disclosure.

FIG. 5 is a user interface element of a mobile device according to an example embodiment of the present disclosure.

FIG. 6 is a flow diagram of a method according to an example embodiment of the present disclosure.

FIG. 7 is a flow diagram of a method according to an example embodiment of the present disclosure.

FIG. 8 is a flow diagram of a method according to an example embodiment of the present disclosure.

FIG. 9 is a block diagram of a mobile device according to an example embodiment of the present disclosure.

### DETAILED DESCRIPTION OF THE EMBODIMENTS

Overview

In one example, there is disclosed a method of switching a conference client software from a higher-functionality state to a reduced-functionality state responsive to a trigger, the method can be performed by a mobile device and can include joining a virtual conference, where the virtual conference can include a video stream and an audio stream. The method can also include detecting the trigger and entering the reduced-functionality state, where one of the streams is limited (e.g., inhibited, reduced, checked, constrained, rationed, narrowed, held back, regulated, or otherwise restricted) to less than its full functionality.

In another example, there is disclosed a mobile device configured to operate a conference client software, the mobile device comprising a processor, a memory, a network interface, and a user interface, where the memory has stored therein software instructions that, when executed, instruct the processor to join a virtual conference via the network interface, the virtual conference including a video stream and an audio stream to the user interface; detect the trigger; and switch to a reduced-functionality state, where one of the streams is limited to less than its full functionality.

### Example Embodiments of the Disclosure

The following disclosure provides many different embodiments, or examples, for implementing different features of the present disclosure. Specific examples of components and arrangements are described below to simplify the disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiment many have different advantages, and no particular advantage is necessarily required of any embodiment.

Mobile computing devices have evolved from the single-function telephones of years past to powerful and highly-functional computing devices that can perform business-critical functions. One such critical function is the ability to join a virtual conference to conduct important business transactions. In an example virtual conference, a virtual conference server (VCS) provides connectivity to a plurality of endpoints, which may be desktop or mobile devices. Typically, each endpoint runs conference client software (CCS) software, which provides connectivity and facilitates communication between the endpoints. In an example virtual conference, one endpoint shares its desktop, which is provided as a video stream to each other endpoint, so that each user sees a substantially identical desktop. A video stream comprising images of users in near real time may also be provided via cameras such as webcams. Users may also be provided with a substantially identical audio stream, either by calling a call-in number, or by an endpoint microphone or headset. In some cases, the CCS may also provide an ability to record the virtual conference, so that a user can view it later.

There are certain challenges connected with the use of mobile clients in virtual conferences. Specifically, even highly capable mobile devices may lack some or all of the capabilities and features of desktop devices. For example, a desktop personal computer (PC) joining a virtual conference may be connected to a public power supply, be equipped with a large LCD screen, include a mouse and keyboard for input, and connect to the internet via a relatively high-speed network connection, such as a gigabit Ethernet, cable, fiberoptic, or a static connection to a nearby WiFi router. In contrast, a mobile device connecting to the same conference may operate from a rechargeable battery, have a capacitive touch screen as a joint input/output device, and be connected to the internet via a relatively low-speed network connection, such a low-bandwidth data network, or constantly-shifting WiFi signals.

In one example method of this disclosure, a set of one or more triggers are defined. Responsive to the trigger, or a combination of triggers, the mobile device may switch from a higher-functionality state to a reduced-functionality state to conserve resources that may be scarce for the mobile client relative to a desktop client. The mobile device may also send a message to the VCS informing the VCS of the reduced-functionality state, which message may be distributed to other endpoints. The reduced-functionality state may be configured, for example, to use less bandwidth, conserve battery, or otherwise adapt all or part of the virtual conference to the mobile device, for example by disabling all or part of either or both of the audio stream or video stream, or by disabling upstream communication, where the user's participation becomes fully passive. In some embodiments, one or more countertriggers may also be defined, responsive to which the mobile device may return to the higher-functionality state. It is intended that the higher-functionality state responsive to the countertrigger need not be the same as the original higher-functionality state, and that reduced-functionality states for different triggers need not be the same. Rather, an engineer could readily/selectively enable and disable features to achieve the desired functionality.

Hence, one or more of the embodiments discussed herein may offer: a reduction in data traffic for a mobile user; a reduction in the power consumption of a mobile device; an increase in audio quality of a mobile device if substantially all data traffic is for audio; a safer driving experience for the virtual meeting attendee; a reduction in the burden of the meeting server; an improvement in the performance of the meeting server; and a savings for meeting server resources.

In the preceding paragraphs and throughout this disclosure, an audio stream encompasses any signal from which a human-perceptible mechanical wave can be reproduced. A countertrigger encompasses any special case of a trigger indicating that the subject of another trigger has changed. Disabling encompasses any removing, reducing, trimming, inhibiting, or otherwise limiting the subject signal or stream, and may be accomplished for example either on a server or on a client. A higher-functionality state encompasses any operating state in which relatively fewer features are disabled than in a reduced-functionality state. A reduced-functionality state encompasses any operating state in which relatively more features are disabled than in a higher-functionality state. A trigger encompasses any signal indicating the occurrence of an event or condition useable for switching to or from a reduced-functionality state. A video stream encompasses any signal from which one or more human-perceptible images can be reconstructed. A virtual conference encompasses any collaborative hardware and software environment that is configured to enable two or more users remote from each other to collaborate and share data.

Non-limiting examples of triggers according to one embodiment of the present disclosure include signals indicating battery-below-threshold, switch to a low-bandwidth data network, signal-below-threshold, switch to hands-free mode, switch to a short-range transceiver, lock screen, and a user input. Non-limiting examples of countertriggers include device plugged in, switch to a high-bandwidth data network, signal-above-threshold, switch from hands-free mode, switch to a short-range transceiver, unlock screen, and a user input. Non-limiting examples of actions that may be taken responsive to a trigger include disabling a video stream, disabling a camera, disabling a shared desktop, disabling audio, reducing audio volume, reducing audio bandwidth, reducing video bandwidth, reducing video frame rate, reducing screen brightness, compressing audio, compressing video, entering passive mode, and entering inactive mode. Non-limiting examples of actions that may be taken responsive to a countertrigger include enabling a video stream, enabling a camera, enabling a shared desktop, enabling audio, increasing audio bandwidth, increasing audio volume, increasing video bandwidth, increasing video frame rate, increasing screen brightness, providing non-compressed audio, waking from passive mode, and waking from inactive mode.

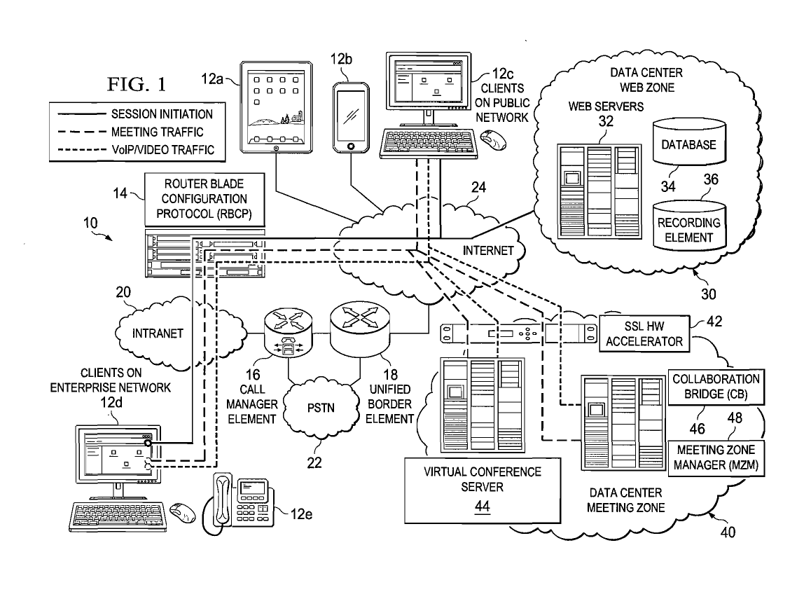

FIG. 1 is a simplified schematic diagram of a virtual conference system 10 for managing resources in accordance with at least one example embodiment. Virtual conference system 10 may include a number of endpoints 12a-e that may achieve suitable network connectivity via various points of attachment. Endpoint 12b is more specifically a mobile device, and may be referred to as mobile device 12b. “Mobile device” encompasses any computing device that is configured to not be used primarily in a single fixed location, and includes [by way of non-limiting examples] any personal digital assistant (PDA), a laptop, electronic notebook, a cellular or mobile telephone of any kind, an iPhone, an IP phone, a Blackberry, a Google Android-based device, an iPad, a tablet, an Ultrabook, a Microsoft Surface, and an in-dash or dashboard-mounted computer.

In the example of FIG. 1, virtual conference system 10 includes an Intranet 20, a public switched telephone network (PSTN) 22, and an Internet 24, which (in this particular example) offers a pathway to a data center web zone 30 and a data center conference zone 40. Data center web zone 30 includes a plurality of web servers 32, a database 34, and a recording element 36. Data center conference zone 40 includes a secure sockets layer hardware (SSL HW) accelerator 42, a plurality of virtual conference servers (VCS) 44, a collaboration bridge 46, and a conference zone manager 48. In at least one example embodiment, each VCS may be configured to coordinate video and voice traffic for a given virtual conference.

Various types of routers and switches may be used to facilitate communications among any of the elements of FIG. 1. For example, a call manager element 16 and a unified border element 18 may be provisioned between PSTN 22 and Intranet 20. Also depicted in FIG. 1 are a number of pathways (e.g., shown as solid or broken lines) between the elements for propagating conference traffic, session initiation, and voice over Internet protocol (VoIP)/video traffic.

In one embodiment, virtual conference system 10 can provide a method to increase efficient bandwidth utilization in online conference scenarios (e.g., WebEx™, Telepresence, GoToConference, Google Hangouts, Skype, etc.). In one example implementation, based on the attendee status, a server can simply send personalized data to the user that is reflective of what the user wants. More specifically, the architecture can divide conference resources into several categories (video data, desktop share data, and audio data). In operation, the system can systematically monitor the attendee's status to identify which parts of the conference resources are not of interest to the attendee. This information can be reported to a server, which can disable that specific supply of information.

Note that in real-world applications, attendees are not required to concentrate on every aspect of an online conference. As users disengage from a given conference, an attendee may not fully quit a conference, and such behavior becomes wasteful. Optimizing this bandwidth usage can reduce the pressure on the server, provide a better allocation of network resources, and conserve relatively scarce mobile resources.

Consider a first voice-only mode in which a server simply sends voice data to a client. During the conference, in this particular example, the attendee is only interested in speech and, therefore, is indifferent to the video data, or to the documents being shared by a given presenter. The architecture of the present disclosure can detect these preferences, for example in a desktop endpoint, by identifying the conference client window being at least partially covered by another window. In other cases, the client can also detect the shown regions of the display screen. In a mobile device, one or more triggers may indicate that audio-only streaming is desirable. This information can be used to more intelligently deliver/prune resources for the endpoint.

When an endpoint is in in an inactive mode, a server could simply keep a session alive and not provide any substantive data to client. This could include no content being provided to the client, while the session is still maintained. In a recovery mode, based on the current attendee's status, the system can be switched back and forth to the appropriate corresponding mode (e.g., automatically). For example, a trigger or triggers may indicate that inactive mode is desirable for a mobile device to conserve mobile resources. A countertrigger or countertriggers may recover or “wake” the inactive mobile device to active mode.

Note that in certain cases, triggers may also result in lower-frame-rate video being provided to the client. In addition, it should be noted that the present disclosure does not confine itself to a strict dichotomy between “full video stream” and “audio only.” In contrast, a slow degradation can be provided between audio, video, multimedia, etc. Any of these variations are fully encompassed by the broad teachings of the present disclosure.

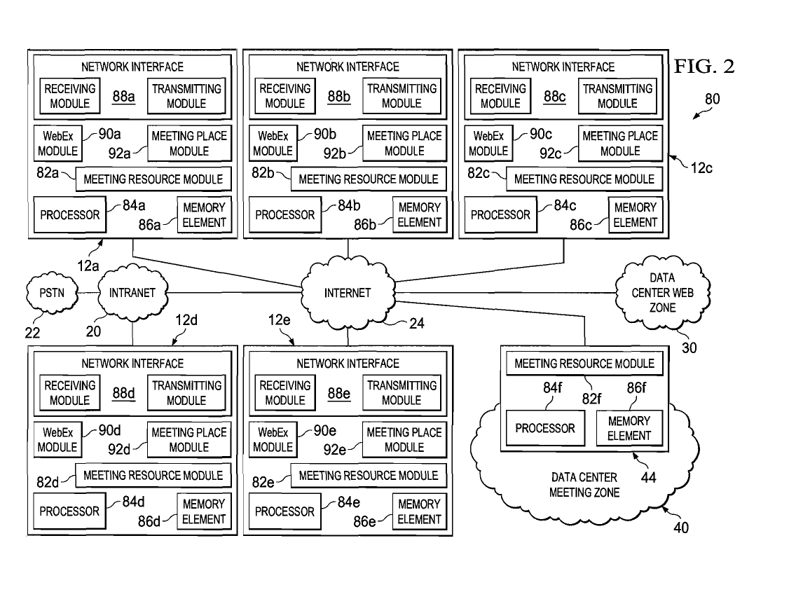

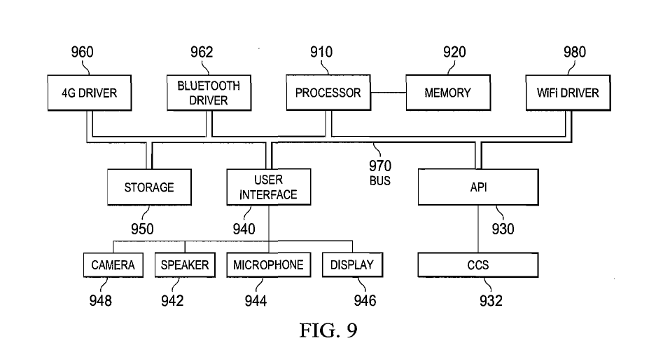

FIG. 2 is a simplified schematic diagram illustrating possible details related to an example infrastructure of a virtual conference system 10 in accordance with at least one example embodiment. Each of endpoints 12a-e are provisioned with a respective conference resource module 82a-e, a respective processor 84a-e, a respective memory element 86a-e, a respective WebEx module 90a-e, a respective meeting place module 92a-e, and a respective network interface 88a-e, which includes a respective receiving module and a respective transmitting module for exchanging data (e.g., for exchanging packets in a network environment). In an example, meeting place module 92, conference resource module 82, and WebEx module 90 are collectively referred to as conference client software (CCS) 932, which may be provided as one or more discrete hardware and/or software modules. Mobile client 12b is described in particular detail with reference to FIG. 9 below.

In at least one example embodiment, each endpoint 12a-e and/or VCS 44 includes software (e.g., as part of meeting resource modules 82a-f) to achieve or to support managing resources, meeting parameters, mobile device activities, etc., as outlined herein. In other embodiments, this feature may be provided externally to any of the aforementioned elements, or included in some other network element to achieve this functionality. Alternatively, several elements may include software (or reciprocating software) that may coordinate in order to achieve the operations, as outlined herein. In still other embodiments, any of the devices of the FIGURES may include any suitable algorithms, hardware, software, components, modules, interfaces, or objects that facilitate in managing resources.

It is imperative to note that FIG. 2 is indicative of just one of the multitude of example implementations of virtual conference system 10. Any of the modules or elements within endpoints 12a-e and/or VCS 44 may readily be replaced, substituted, or eliminated based on particular needs. Furthermore, although described with reference to particular scenarios, where a given module (e.g., WebEx module 90a-e, meeting place module 92a-e, conference resource module 82a-e, etc.) is provided within endpoints 12a-e or VCS 44, any one or more of these elements may be provided externally, or consolidated and/or combined in any suitable fashion. In certain instances, certain elements may be provided in a single proprietary module, device, unit, etc. in order to achieve the teachings of the present disclosure.

Endpoints 12a-e are representative of any type of client or user wishing to participate in a conference session in virtual conference system 10 (e.g., or in any other online platform). Furthermore, endpoints 12a-e may be associated with individuals, clients, customers, or end users wishing to participate in a conference session in virtual conference system 10 via some network. The term ‘client device’ is inclusive of devices used to initiate a communication, such as a computer, mobile device, or any other device, component, element, or object capable of initiating voice, audio, video, media, or data exchanges within virtual conference system 10. Endpoints 12a-e may also be inclusive of a suitable user interface 940, including for example a microphone, a camera, a display, or a keyboard or other terminal equipment. Endpoints 12a-e may also be any device that seeks to initiate a communication on behalf of another entity or element, such as a program, a proprietary conferencing device, a database, or any other component, device, element, or object capable of initiating an exchange within virtual conference system 10. “Data” encompasses any type of numeric, voice, video, media, or script data, or any type of source or object code, or any other suitable information in any appropriate format that may be communicated from one point to another.

VCS 44 and web servers 32 are network elements that manage (or that cooperate with each other in order to manage) aspects of a conference session. “Network element” encompasses any type of servers (e.g., a video server, a web server, etc.), routers, switches, gateways, bridges, loadbalancers, firewalls, inline service nodes, proxies, network appliances, processors, modules, or any other suitable device, component, element, or object operable to exchange information in a network environment. This network element may include any suitable hardware, software, components, modules, interfaces, or objects that facilitate the operations thereof. This may be inclusive of appropriate algorithms and communication protocols that allow for the effective exchange (reception and/or transmission) of data or information. In one particular example, VCS 44 and web servers 32 are servers that may interact with each other via the networks of FIG. 1.

Intranet 20, PSTN 22, and Internet 24 represent a series of points or nodes of interconnected communication paths for receiving and transmitting packets of information that propagate through virtual conference system 10. These networks may offer connectivity to any of the devices or endpoints of FIG. 1. Moreover, Intranet 20, PSTN 22, and Internet 24 offer a communicative interface between sites (and/or participants, rooms, etc.) and may be any local area network (LAN), wireless LAN (WLAN), metropolitan area network (MAN), wide area network (WAN), extranet, Intranet, virtual private network (VPN), virtual LAN (VLAN), or any other appropriate architecture or system that facilitates communications in a network environment.

Intranet 20, PSTN 22, and Internet 24 may support a transmission control protocol (TCP)/IP, or a user datagram protocol (UDP)/IP in particular embodiments of the present disclosure; however, Intranet 20, PSTN 22, and Internet 24 may alternatively implement any other suitable communication protocol for transmitting and receiving data packets within virtual conference system 10. Note also that Intranet 20, PSTN 22, and Internet 24 may accommodate any number of ancillary activities, which may accompany a conference session. This network connectivity may facilitate all informational exchanges (e.g., notes, virtual whiteboards, PowerPoint presentations, e-mailing, word-processing applications, etc.). Along similar reasoning, Intranet 20, PSTN 22, and Internet 24 may foster all such communications and, further, be replaced by any suitable network components for facilitating the propagation of data between participants in a conferencing session.

It should also be noted that endpoints 12a-e and VCS 44 may share (or coordinate) certain processing operations. Using a similar rationale, their respective memory elements may store, maintain, and/or update data in any number of possible manners. Additionally, any of the illustrated memory elements or processors may be removed, or otherwise consolidated such that a single processor and a single memory location is responsible for certain activities associated with managing resources. In a general sense, the arrangement depicted in FIG. 2 may be more logical in its representations, whereas a physical architecture may include various permutations/combinations/hybrids of these elements.

Note that in certain example embodiments, the resource management functions outlined herein may be implemented by logic encoded in one or more non-transitory tangible media (e.g., embedded logic provided in an application specific integrated circuit (ASIC), digital signal processor (DSP) instructions, software (potentially inclusive of object code and source code) to be executed by a processor, or other similar machine, etc.). In some of these instances, a memory element may store data used for the operations described herein. This includes the memory element being able to store software, logic, code, or processor instructions that may be executed to carry out the activities described in this disclosure. A processor may execute any type of instructions associated with the data to achieve the operations detailed in this disclosure. In one example, a processor may transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

In one example implementation, meeting resource modules 82a-f include software in order to achieve the resource management functions outlined herein. These activities may be facilitated by VCS 44 and/or the various endpoints 12a-e. VCS 44 and/or endpoints 12a-e may include memory elements for storing information to be used in managing resources, as outlined herein. Additionally, VCS 44 and/or endpoints 12a-e may include a processor that may execute software or an algorithm to perform management of resources, as discussed in this Disclosure. These devices may further keep information in any suitable memory element (random access memory (RAM), ROM, EPROM, EEPROM, ASIC, etc.), software, hardware, or in any other suitable component, device, element, or object where appropriate and based on particular needs. Any possible memory items (e.g., database, table, cache, etc.) should be construed as being encompassed within the broad term ‘memory element.’ Similarly, any of the potential processing elements, modules, and machines described in this disclosure should be construed as being encompassed within the broad term ‘processor.’

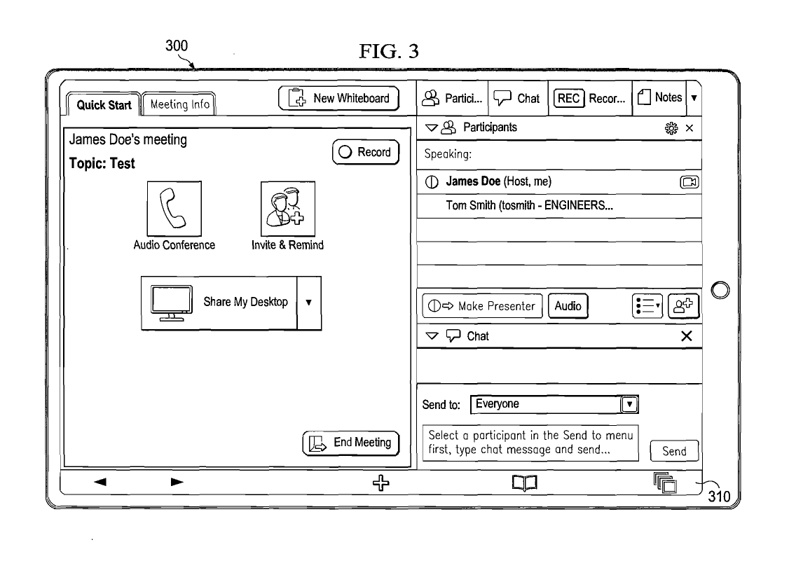

FIG. 3 is a screenshot illustrating an example user interface element 300 associated with CCS 932 in at least one example of a mobile device 12b. In this particular example, a mobile menu bar 310 is also provided. Note that any number of triggers, countertriggers, or notifications can be provided via a pop-up notification, pop-up menu, etc. Hence, any of the following activities can be facilitated by pop-ups, dialog box, or similar graphics that alert the user (or the system) of some characteristic, parameter, resource, condition, etc. Note also that any of the following activities and operations do not simply apply to video versus desktop sharing, but also apply to any audio/verbal prompts/inputs (e.g., including for noisy environment muting, volume control, etc.).

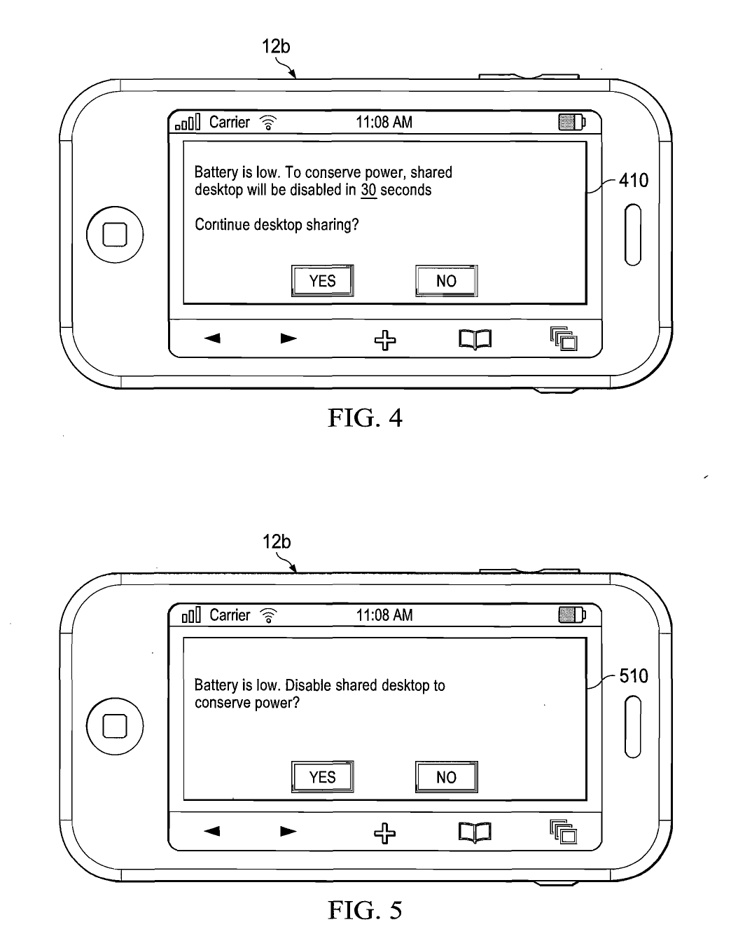

FIG. 4 is a user interface element of a mobile device 12b according to an example embodiment of the present disclosure, displaying a confirmation dialog 410. In this example, a trigger has informed CCS 932 that the battery is low. Confirmation dialog 410 asks the user to confirm entering the reduced functionality state. In this case, a default is provided, which may be useful if there is a significant chance that the user will not see confirmation dialog 410. For example, CCS 932 may default to disabling desktop sharing after some time interval (e.g., 30 seconds) if no response is received from the user. More formally, this example may include three distinct triggers, namely a low-battery event trigger (A), a timer countdown trigger indicating that the timer counted down to 30 (B), and a user confirmation trigger (C). The condition for entering a reduced-functionality state (R) may include a Boolean logic function of these three values, such as R=A×(B+ C̅).

In other example embodiments, other types of user prompts may be provided, and are intended to be encompassed by this disclosure. For example, instead of or in addition to confirmation dialog 410, mobile device 12b could provide an audible prompt over speaker 942 (FIG. 9), and receive an audio response over microphone 944. In another example, mobile device 12b may provide a visual or audio prompt and use camera 948 (FIG. 9) to capture a user gesture that operates as either a “Yes” or “No” response to a question.

FIG. 5 is a user interface element of a mobile device 12b according to an example embodiment of the present disclosure, displaying a confirmation dialog 510. Unlike the example of FIG. 4, no default is provided. In this case, desktop sharing will continue until the user responds to confirmation dialog 510. If the user responds yes, then desktop sharing will be disabled. If the user responds “no,” then desktop sharing will be continued. Similar confirmation dialogs and other user interface elements may be used to verify taking other reduced-functionality actions in response to other triggers, or for restoring functionality in response to countertriggers.

More formally, the embodiment of FIG. 5 includes two triggers, a low-battery event trigger (A) and a confirmation dialog trigger (B). The condition for entering a reduced-functionality state (R) may include a Boolean logic function of these two values, such as R=A×B.

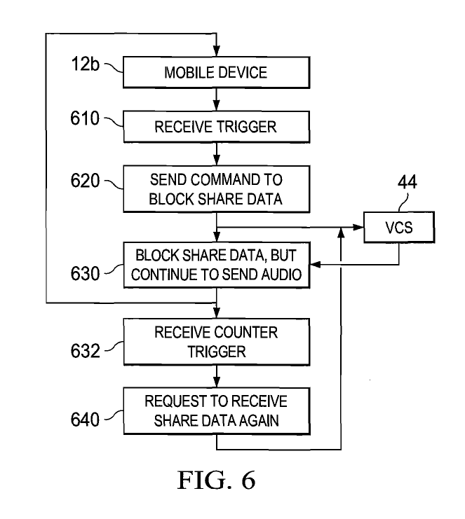

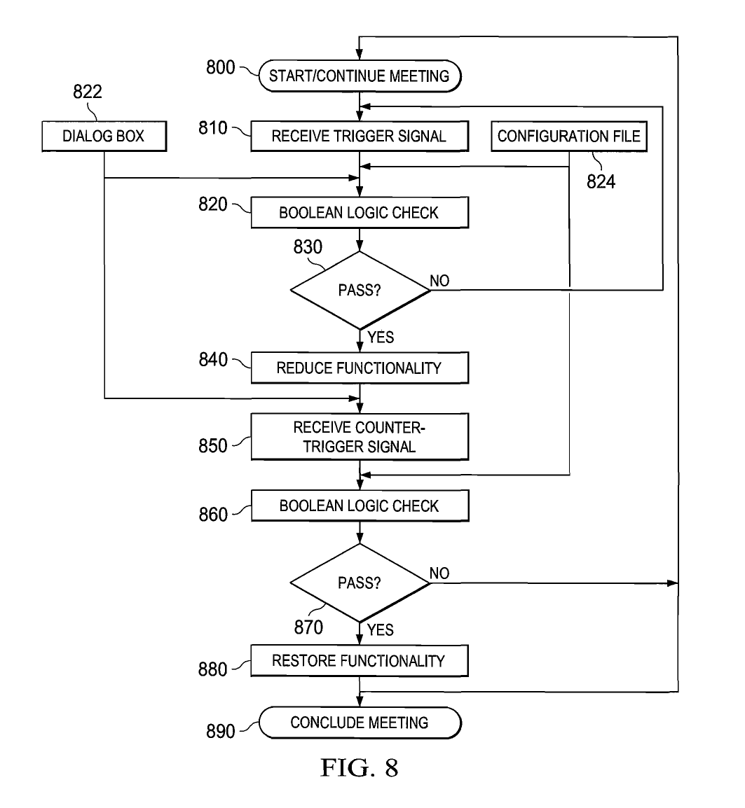

FIG. 6 is a flow diagram of signal traffic between CCS 932 operating on mobile device 12b and VCS 44 in connection with the method described more fully in FIG. 8. In block 610, CCS 932 receives a trigger from mobile device 12bh. In block 620, responsive to the trigger, CCS 932 sends a signal to VCS 44 requesting a reduced functionality state, such as blocking a shared desktop video stream. In some embodiments, VCS 44 may notify other endpoints that mobile device 12b is entering a reduced-functionality state. In block 630, VCS 44 sends a modified data stream that includes an audio stream but not a video stream. In block 632, CCS 932 receives a countertrigger, and in block 640 sends a request to VCS 44 requesting that the higher-functionality audio and video streams be restored. In some embodiments, VCS 44 may notify other endpoints that mobile device 12b has restored a higher-functionality state.

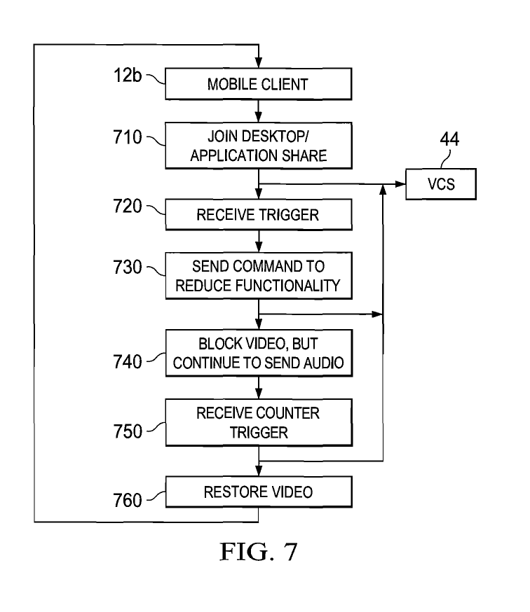

FIG. 7 is a flow diagram of signal traffic between CCS 932 operating on mobile device 12b and VCS 44 in connection with the method described more fully in FIG. 8. In block 710, mobile device 12b joins a virtual conference provided by VCS 44, in this case sending an audio and video screen that shares the desktop of mobile device 12b. In block 720, CCS 932 receives a trigger, and in 730, CCS 932 sends VCS 44 a notification that it is entering a reduced-functionality state and will no longer be sending a video stream. In block 740, video is disabled, but audio is still sent. In some embodiments, VCS 44 may notify other endpoints that mobile device 12b has entered a reduced-functionality state. In block 750, a countertrigger is received, and in block 760, CCS 932 sends to VCS 44 a message indicating that the higher-functionality state has been restored and the full audio and video stream will be supplied again. In some embodiments, VCS 44 may notify other endpoints that mobile device 12b has been restored to a higher-functionality state.

FIG. 8 is a flowchart illustrating an example method of the present disclosure. In the example method, a virtual conference begins in block 800. In block 810, CCS 932 receives one or more triggers, for example via API 930. In block 820, the one or more triggers are subject to a Boolean logic condition. For example, the Boolean logic condition may be that the screen locked and a low-bandwidth data network is in use. In another example, the condition may be a combination of the trigger and a user interface element. For example, the condition may be true only if a low-bandwidth data network is in use and a configuration option is set to reduce functionality on entering a low-bandwidth data network, or the condition may be true only if a low-bandwidth data network is in use and a user clicks “Yes” in a dialog box 822 seeking confirmation of the reduced functionality. Configuration file 824 may also be used in these activities.

In block 830, if the Boolean logic condition does not pass the test, execution returns to block 800 and the virtual conference is continued. If, on the other hand, the Boolean logic condition passes the test in block 830, then in block 840, CCS 932 enters a reduced-functionality state. CCS 932 may stay in the reduced-functionality state until a counter-trigger is received in block 850. After the countertrigger is received, a Boolean logic condition is tested in block 860. In block 870, if the condition does not pass the Boolean logic test, then execution returns to block 800. If, on the other hand, the Boolean logic condition passes the test in block 870, the higher-functionality state is restored in block 880. In block 890, the meeting is concluded.

In the preceding paragraphs and throughout this disclosure, a Boolean logic condition encompasses any function of one or more Boolean variables, the output of which is a Boolean value. Boolean values need not be represented by a native Boolean type. For example, a numeric variable may be a Boolean value, where “0” represents false, and any non-zero value represents true.

FIG. 9 is a block diagram that illustrates possible details associated with mobile device 12b. As described above, mobile device 12b may be controlled by a processor 910, which is communicatively coupled to a memory 920. In an example, processor 910 is communicatively coupled to other system elements via bus 970. Those elements may include, by way of non-limiting example, a 4G driver 960, a Bluetooth driver 962, a WiFi driver 980, an application programming (or program) interface (API) 930, a user interface 940, and storage 950, which in some cases may be a species of memory 920. It is intended that any of the above elements can be realized in hardware, software, firmware, or any combination thereof.

In this example, 4G driver 960 is disclosed as a species of low-bandwidth data network, and any other low-bandwidth data network may be substituted. A low-bandwidth data network encompasses any communication medium of a mobile device, whether analog, digital, or mixed-signal, that is relatively encumbered with respect to a high-bandwidth data network, including for example by limited bandwidth, limited data volume, limited availability, or increased cost. Non-limiting examples of low-bandwidth data networks include analog cellular networks, digital PCS networks, 2G data networks, 3G data networks, 4G WiMAX, and 4G LTE data networks. In contrast, WiFi driver 980 is disclosed as a species of high-bandwidth data network. A high-bandwidth data network encompasses any network that is relatively free of the encumbrance of a low-bandwidth data network, and may include for example an IEEE 802.11(n) WiFi network or an Ethernet, Firewire, USB, fiberoptic, or other wired network. In some example embodiments, the foregoing lists may include some crossover. For example, a mobile device may have access to a higher-bandwidth 4G or better network, but may default to a lower-bandwidth 3G or 2G network if a 4G signal cannot be found. In that case, the 4G network may be treated as a the high-bandwidth data network for purposes of this disclosure, while the default 3G or 2G network may be treated as the low-bandwidth data network. In yet other embodiments, the roles may be reversed. For example, a wireless carrier may provide for unlimited monthly data consumption on a 2G or 3G network, while 4G traffic may be capped. In that case, both networks have a species of encumbrance, and the division between the two networks may depend on a user preference. For example, to conserve 4G data consumption for other desired activities, the user may elect to treat the 2G or 3G network as the relatively-unencumbered “high-bandwidth data network” for purposes of this specification, and treat the 4G data network as the relatively-encumbered “low-bandwidth data network.” Thus, the broad definitions of the two foregoing terms are not intended to be limited to any specific configuration.

Bluetooth driver 962 is disclosed as a species of short-range transceiver. A short-range transceiver encompasses any communication device or medium configured to operate as an intermediary between a user and user interface 940. In many examples, short-range transceiver will be configured to operate over short ranges compared to WiFi driver 980 and 4G driver 960. Short-range transceiver may include for example a Bluetooth wireless interface or headset plugged into a headset jack, and may be used when a mobile device is used in a hands-free mode. Hands-free mode encompasses any mode in which a user is enabled to operate with the user interface by non-primary means.

User interface 940 encompasses any combination of hardware, software, and firmware configured to enable a user to interact with mobile device 12b, whether or not in real-time. In the example embodiment, user interface 940 includes a speaker 942, a microphone 944, and a touch-sensitive display 946, which acts as a combined input/output device, and a camera 948 such as a webcam. User interface 940 may include software services such as a graphical user interface, including real-time dialog boxes that solicit input or confirmation from a user. User interface 940 may also include configuration files or configuration screens that permit a user to control certain behavior of CCS 932 with forethought.

Storage 950 is disclosed as an example embodiment of a non-volatile memory medium, which may be a species of memory 920. In some embodiments, memory 920 and storage 950 may be provided by a single physical device, which may be partitioned into different regions. In other embodiments, memory 920 and storage 950 may be separate devices, with memory 920 being a relatively low-latency volatile memory device, and storage 950 being a relatively high-latency non-volatile memory device. Many other configurations are also possible, and are intended to be encompassed within the broad scope of this specification.

Application programming interface 930 encompasses any API, any intermediate layer in hardware, software, firmware, or a combination thereof that enables CCS 932 to send or receive data, signals, messages, or triggers to or from mobile device 12b. CCS 932 encompasses any hardware, software, firmware, or any combination within an endpoint 12 that enables a user to participate in or interact with a virtual conference. In certain embodiments, CCS 932 may include a WebEx module 90, conference resource module 82, and meeting place module 92 as described in connection with FIG. 2. In the example embodiment, CCS 932 communicates with processor 910 and other elements of mobile device 12b via API 930.

The particular embodiments of the present specification may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

In example implementations, at least some portions of the processing activities outlined herein may also be implemented in software. In some embodiments, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present specification encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the specification, to limit this specification in any way that is not otherwise reflected in the appended claims.

What is claimed is:

1. A method of switching a conference client software from a higher-functionality state to a reduced-functionality state, the method comprising:
joining a virtual conference, the virtual conference including a video stream and an audio stream;
detecting a trigger; and
entering the reduced-functionality state, wherein one of the streams is limited to less than its full functionality.

2. The method of claim 1, wherein detecting the trigger comprises receiving a notification from an application program interface of a mobile device.

3. The method of claim 1, wherein entering the reduced-functionality state comprises an action of a mobile device being selected from a group consisting of:
a) disabling a video stream of the mobile device;
b) disabling a camera of the mobile device;
c) disabling a shared desktop;
d) disabling audio of the mobile device;
e) reducing audio volume of the mobile device;
f) reducing audio bandwidth of the mobile device;
g) reducing video bandwidth of the mobile device;
h) reducing video frame rate of the mobile device;
i) reducing screen brightness of the mobile device;
j) compressing audio of the mobile device;
k) compressing video of the mobile device;
l) entering passive mode of the mobile device; and
m) entering inactive mode of the mobile device.

4. The method of claim 1, wherein the trigger is selected from a group consisting of:
a) a battery-below a threshold;
b) a switch to a low-bandwidth data network;
c) a signal-below a threshold;
d) a switch to a hands-free mode;
e) a switch to a short-range transceiver;
f) a lock screen action; and
g) a user input.

5. The method of claim 4, further comprising detecting a second trigger, wherein entering the reduced-functionality state is performed upon a Boolean logic condition of two or more triggers.

6. The method of claim 1 further comprising:
receiving a countertrigger; and
switching from the reduced-functionality state to the higher-functionality state.

7. The method of claim 6, wherein the countertrigger comprises an event selected from a group consisting of:
a) a device being plugged in;
b) a switch to a high-bandwidth data network;
c) a signal-above a threshold;
d) a switch from a hands-free mode;
e) a switch to a short-range transceiver;
f) an unlock screen; and
g) a user input.

8. The method of claim 6, wherein switching to the higher-functionality state comprises taking an action selected from a group consisting of:
a) enabling a video stream;
b) enabling a camera;
c) enabling a shared desktop;
d) enabling audio;
e) increasing audio bandwidth;
f) increasing audio volume;
g) increasing video bandwidth;
h) increasing video frame rate;
i) increasing screen brightness;
j) providing non-compressed audio;
k) waking from passive mode; and
l) waking from inactive mode.

9. A mobile device configured to operate conference client software, the mobile device comprising a processor, a memory, a network interface, and a user interface, wherein the memory has stored therein software instructions that, when executed, instruct the processor to:
join a virtual conference via the network interface, the virtual conference including a video stream and an audio stream to the user interface;
detect a trigger; and
switch to a reduced-functionality state, wherein one of the streams is limited to less than its full functionality.

10. The mobile device of claim 9, wherein detecting the trigger comprises receiving a notification via an application program interface of the mobile device.

11. The mobile device of claim 9, wherein entering the reduced-functionality state comprises an action of the mobile device being selected from a group consisting of:
a) disabling a video stream of the mobile device;
b) disabling a camera of the mobile device;
c) disabling a shared desktop;
d) disabling audio of the mobile device;
e) reducing audio volume of the mobile device;
f) reducing audio bandwidth of the mobile device;
g) reducing video bandwidth of the mobile device;
h) reducing video frame rate of the mobile device;
i) reducing screen brightness of the mobile device;
j) compressing audio of the mobile device;
k) compressing video of the mobile device;
l) entering passive mode of the mobile device; and
m) entering inactive mode of the mobile device.

12. The mobile device of claim 9, wherein the trigger is selected from a group consisting of:
a) a battery-below a threshold;
b) a switch to a low-bandwidth data network;
c) a signal-below a threshold;
d) a switch to a hands-free mode;
e) a switch to a short-range transceiver;
f) a lock screen action; and
g) a user input.

13. The mobile device of claim 11, wherein the software instructions further instruct the processor to receive a second trigger, wherein switching to a reduced-functionality state is performed only upon a Boolean logic condition of two or more triggers.

14. The mobile device of claim 9, wherein the instructions further instruct the processor to:
receive a countertrigger; and
switch from the reduced-functionality state to the higher-functionality state.

15. The mobile device of claim 14, wherein the countertrigger comprises an event selected from a group consisting of a device being plugged in, a switch to a high-bandwidth data network, a signal-above a threshold, a switch from a hands-free mode, a switch to a short-range transceiver, an unlock screen, and a user input.

16. The mobile device of claim 14, wherein switching to the higher-functionality state comprises taking an action selected from a group consisting of:
a) enabling a video stream;
b) enabling a camera;
c) enabling a shared desktop;
d) enabling audio;
e) increasing audio bandwidth;
f) increasing audio volume;
g) increasing video bandwidth;
h) increasing video frame rate;
i) increasing screen brightness;
j) providing non-compressed audio;
k) waking from passive mode; and
l) waking from inactive mode.

17. A non-transitory storage media having stored thereon software instructions for a mobile device, the software instructions configured, when executed, to instruct a processor to:
join a virtual conference, the virtual conference including a video stream and an audio stream;
detect a trigger; and
switch to a reduced-functionality state, wherein one of the streams is limited to less than its full functionality.

18. The media of claim 16, wherein detecting the trigger comprises receiving a notification from an application program interface of the mobile device.

19. The media of claim 16, wherein entering the reduced-functionality state comprises an action of the mobile device being selected from a group consisting of:
a) disabling a video stream of the mobile device;
b) disabling a camera of the mobile device;
c) disabling a shared desktop;
d) disabling audio of the mobile device;
e) reducing audio volume of the mobile device;
f) reducing audio bandwidth of the mobile device;
g) reducing video bandwidth of the mobile device;
h) reducing video frame rate of the mobile device;
i) reducing screen brightness of the mobile device;
j) compressing audio of the mobile device;
k) compressing video of the mobile device;
l) entering passive mode of the mobile device; and
m) entering inactive mode of the mobile device.

20. The media of claim 16, wherein the trigger is selected from a group consisting of battery-below-threshold, switch to a low-bandwidth data network, signal-below-threshold, switch to hands-free mode, switch to a short-range transceiver, lock screen, and a user input.
